(19) United States
(12) Patent Application Publication
(10) Pub. No.: US 2015/0028016 A1
(43) Pub. Date: Jan. 29, 2015

(54) Inrush Current Control System

(71) Applicant: ELECTROLUX HOME PRODUCTS CORPORATION N.V., Brussel (BE)

(72) Inventors: Alessandro Cecco, Sedegliano (UD) (IT); Hubert Dorigo, Sarmede (TV) (IT); Paolo Driussi, Zoppola (PN) (IT); Marco Lorenzi, Pordenone (IT)

(73) Assignee: ELECTROLUX HOME PRODUCTS CORPORATION N.V., Brussel (BE)

(21) Appl. No.: 14/354,196

(22) PCT Filed: Oct. 24, 2012
(86) PCT No.: PCT/EP2012/004448

§ 371 Date: Apr. 25, 2014

(30) Foreign Application Priority Data
Oct. 25, 2011 (EP) 111868564.8

(51) Int. Cl. D06F 39/04; D06F 33/02; H05B 1/02; H02H 9/00; H02H 9/02

(52) U.S. Cl. CPC D06F 39/04; H02H 9/005; H02H 9/02; H05B 1/0244; D06F 33/02
USPC 219/209; 68/15; 34/108

(57) ABSTRACT

A laundry machine (200) adapted to process laundry (220) by means of an operative fluid is provided. The laundry machine (200) comprises a drum (215) for housing the laundry (220), an electrical heater apparatus (280) configured to heat up the operative fluid, at least one electrical device (105), and an inverter supply block (100) for electrically supplying the at least one electrical device (105). The inverter supply block (100) comprises a bulk capacitor (130). The laundry machine (200) further comprises a limiter circuit (300; 280) configured to temporarily limit a charging current drawn by the inverter supply block (100) during a bulk capacitor (130) charging phase. The limiter circuit (300; 280; 330) is configured to selectively force the passage of the charging current through the electrical heater apparatus (280).

### FIELD OF THE INVENTION

The present invention relates to laundry machines. Particularly, the invention relates to a control system for limiting the inrush current drawn by the inverter supply block of a laundry machine.

DESCRIPTION OF THE RELATED ART

In the present description the term “laundry machine” will refer to washing machines, tumble dryers as well as washing/drying machines adapted to process (e.g., wash, dry or wash/dry) laundry by means of an operative fluid; depending on the type of laundry machine, in the present description the term “operative fluid” may refer to water or water mixed with washing and/or rinsing products (washing machine and washing/drying machine), or to drying air (tumble dryer and washing/drying machine).

Typically, a laundry machine is provided with a rotatable drum adapted to contain laundry; the rotatable drum is operated by an electric motor, such as a brushless motor or an asynchronous motor. In order to control the rotational speed of such electric motor, it is known to power supply the latter by an inverter supply block (i.e., a supply source including an inverter). An inverter supply block may be advantageously exploited for supplying other apparatuses of the laundry machine, such as for example compressors, pumps and fans.

FIG. 1 schematically illustrates in terms of functional elements an example of a known inverter supply block 100 for the supplying of an electric motor 105 of a laundry machine (not illustrated).

The inverter supply block 100 is mounted on a Printed Circuit Board (PCB) 110 installed within the housing of the laundry machine. The inverter supply block 100 is adapted to selectively receive from an AC power supply—e.g., the mains—an input AC voltage Vin through an input switch 112, whose opening and closing is set by a logic circuit block 113, such as the control unit of the laundry machine. For example, the supply block 100 includes an input port having a first terminal 114 coupled to the line terminal of the mains—identified in figure with the reference 115—through the input switch 112, and a second terminal 116 directly coupled to the neutral terminal of the mains identified in figure with the reference 117.

When the input switch 112 is closed, the input voltage Vin is provided to the inverter supply block 100, which outputs a corresponding set of AC supply voltages Vs1, Vs2 and Vs3 to be provided to the electric motor 105 for the operation thereof.

The inverter supply block 100 includes a rectifier circuit 120, e.g., a diode bridge, adapted to convert the input voltage Vin (which is a sinusoidal voltage) into a unipolar rectified voltage Vr. The variations in the magnitude of the rectified voltage Vr are reduced by a filter circuit 125 comprising a bulk capacitor 130. Even if still containing an unavoidable time-dependent component, the filtered voltage Vf output by the filter circuit 130 is a substantially DC voltage. The filtered voltage Vf is fed to an inverter circuit 135, which accordingly generates the supply voltages Vs1, Vs2 and Vs3 by means of switching elements (not illustrated) driven by a timing logic circuit 140. The inverter circuit 135 is configured so that the supply voltages Vs1, Vs2 and Vs3 substantially oscillate at a certain frequency with a certain magnitude and a certain mutual phase difference specifically set to correctly drive the motor 105.

Since the bulk capacitor 130 typically has a quite high capacity, e.g., on the order of 4-500 μF, the above described inverter supply block 100 has a high inrush current. As it is well known to those skilled in the art, the term “inrush current” means the maximum instantaneous input current drawn by an electrical device when turned on. When the input switch 112 is closed, and the input voltage Vin is provided to the inverter supply block 100 for the first time, the bulk capacitor 130 is completely discharged. Thus, the input current initially drawn from the mains by the inverter supply block 100 for charging the bulk capacitor 130 (i.e., the inrush current of the supply block 100) has a high value. The period of time spent for charging the bulk capacitor 130 will be hereinafter referred to as “bulk capacitor charging phase”. Since such high inrush current may gradually damage the components of the inverter supply block 100, and potentially cause the blowing of the supply's fuses (not illustrated) and/or the triggering of circuit breakers (also not illustrated), a limiter circuit 145 is typically provided between the switch 112 and the mains providing the input voltage Vin (as illustrated in FIG. 1), or between the switch 112 and the input of the inverter supply block 110, to limit the current drawn by the latter during the bulk capacitor charging phase.

According to a solution known in the art, the limiter circuit 145 includes a Negative Temperature Coefficient (NTC) thermistor 150 connected in parallel with a switch 155, whose opening and closing is for example set by the same logic circuit block 113 driving the switch 112. As it is well known to those skilled in the art, an NTC thermistor has a resistance which decreases as its temperature increases. Initially, the switch 155 is open, and the NTC thermistor 150 has a relatively high resistance. When the switch 112 is closed, the current drawn by the inverter supply block 100 from the mains for charging the (initially discharged) bulk capacitor 130 is limited because of the resistance of the NTC thermistor 150, and thus the corresponding inrush current value advantageously results to be lower. The voltage drop initially introduced by the relatively high resistance of the NTC thermistor 150—which affects the actual voltage provided to the input of the inverter supply block 100—decreases over time, since the current flow heats up the NTC thermistor 150, correspondingly reducing its resistance. After a predetermined amount of time, set in such a way to allow the bulk capacitor 130 to be sufficiently charged, the switch 155 closes. Therefore, after the completion of the bulk capacitor charging phase, the NTC thermistor 150 is bypassed, so that the actual voltage provided to the input of the inverter supply block 100 equals the input voltage Vin provided by the mains.

### SUMMARY OF THE INVENTION

According to the Applicant, the aforementioned solution for limiting the inrush current of the inverter supply block of a laundry machine is not efficient in terms of cost, design requirements and space occupation within the housing accommodating all the components of the laundry machine. Indeed, the solution described above requires a dedicated limiter circuit comprising an NTC thermistor, which has to be installed and properly interconnected with the inverter supply block within the housing of the laundry treatment apparatus.

The Applicant has observed that a laundry machine is already provided with resistive elements having a resistance value comparable to that of the NTC thermistor usually employed to reduce the inrush current. Such resistive elements already installed in the laundry machine are the resistance heater(s) normally included in the laundry machine heater apparatus and used to heat up the operative fluid (e.g., water, for example mixed with washing and/or rinsing products, in a washing machine or washing/drying machine, or air in a tumble drier or in a washing/drying machine) adapted to process (e.g, wash or dry) the laundry contained in the laundry machine drum. The Applicant has found that the abovementioned drawbacks may be solved by means of limiting the inrush current by exploiting such already present resistive elements in place of using a dedicated NTC thermistor. In other words according to the invention resistive elements already present in the machine are expediently exploited for limiting the inrush current during the charging of the bulk condenser.

An aspect of the present invention provides for a laundry machine adapted to process laundry by means of an operative fluid. The laundry machine comprises a drum for housing the laundry, an electrical heater apparatus configured to heat up the operative fluid, at least one electrical device, and an inverter supply block for electrically supplying the at least one electrical device; the inverter supply block comprises a bulk capacitor. The laundry machine further comprises a limiter circuit configured to temporarily limit a charging current drawn by the inverter supply block during a bulk capacitor charging phase. The limiter circuit is configured to selectively force the passage of the charging current through the electrical heater apparatus.

Compared to the known solution, the proposed limiter circuit is less expensive and do not require the installation of a dedicated NTC thermistor.

The electrical heater apparatus comprises at least one electric resistance heater. The limiter circuit is advantageously configured to selectively force the passage of the charging current through the at least one electric resistance heater during the bulk capacitor charging phase.

According to an embodiment of the present invention, the limiter circuit further comprises a switch switchable between a first configuration, wherein the inverter supply block is coupled to an AC power supply for receiving the charging current through the at least one electric resistance heater, and a second configuration, wherein the inverter supply block is coupled to the AC power supply for receiving the charging current bypassing the electric resistance heater.

The AC power supply comprises a first supply terminal and a second supply terminal. The electrical heater apparatus is coupled between the first supply terminal and the second supply terminal. According to an embodiment of the present invention, the inverter supply block includes a first input terminal selectively connectible to the first supply terminal through a further switch and a second input terminal selectively connectible to the second supply terminal or to the electrical heater apparatus through the switch.

The inverter supply block comprises a rectifier circuit adapted to convert a sinusoidal input voltage provided by the AC power supply into a unipolar rectified voltage and a filter circuit adapted to generate a filtered voltage from the rectified voltage; the filter circuit includes the bulk capacitor. The inverter supply block further comprises an inverter circuit adapted to generate supply voltages for the at least one electrical device from the filtered voltage.

According to an embodiment of the present invention, the laundry machine may be a washing machine, a dryer machine, or a washing/drying machine.

According to an embodiment of the present invention, said electrical device comprises at least one among an electric motor, a compressor, a pump, and a fan.

Another aspect of the present invention relates to a method for operating a laundry machine adapted to process laundry by means of an operative fluid. Said laundry machine comprises a drum for housing the laundry, an electrical heater apparatus configured to heat up the operative fluid, at least one electrical device, and an inverter supply block for electrically supplying the at least one electrical device. The inverter supply block comprises a bulk capacitor. The method comprises temporarily limiting a charging current drawn by the inverter supply block during a bulk capacitor charging phase. Said temporarily limiting a charging current comprises selectively forcing the passage of the charging current through the electrical heater apparatus.

According to an embodiment of the present invention said selectively forcing the passage of the charging current through the electrical heater apparatus comprises selectively forcing the passage of the charging current through at least one electric resistance heater during the bulk capacitor charging phase.

According to an embodiment of the present invention said method further includes coupling the inverter supply block to an AC power supply through the at least one electric resistance heater during the bulk capacitor charging phase, and coupling the inverter supply block to the AC power supply bypassing the electric resistance heater after the bulk capacitor charging phase.

### BRIEF DESCRIPTION OF THE DRAWINGS

These and other features and advantages of the present invention will be made apparent by the following description of some exemplary and non limitative embodiments thereof; for its better intelligibility, the following description should be read making reference to the attached drawings, wherein:

FIG. 1 schematically illustrates in terms of functional elements a known inverter supply block for the supplying of an electric motor of a laundry machine;

FIG. 2 is a schematic sectional view of a laundry machine;

FIG. 3 schematically illustrates in terms of functional elements a limiter circuit for limiting the inrush current of the inverter supply block of FIG. 1 according to an embodiment of the present invention, and

FIGS. 4A-4C illustrate the flow of the current drawn by the inverter supply block according to an embodiment of the present invention.

### DETAILED DESCRIPTION OF THE INVENTION

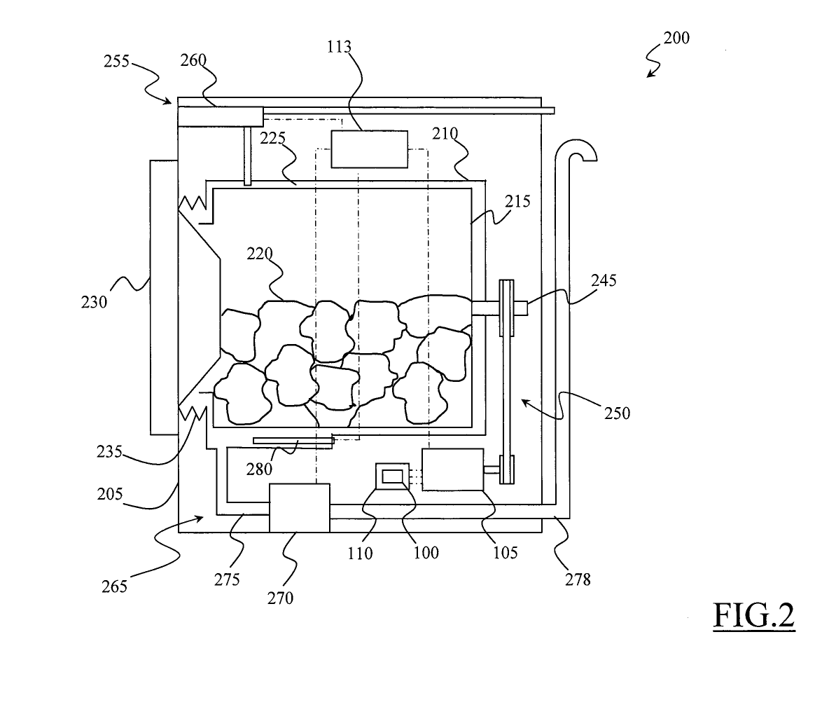

With reference to the figures, FIG. 2 is a schematic sectional view of a laundry machine wherein a solution according to an embodiment of the present invention may be applied. In the exemplary embodiment herein considered, the laundry machine is a washing machine; however the invention may be applied as well to a washing/drying machine and to a tumble dryer.

The washing machine 200 comprises an external casing or housing 205 in which a washing tub 210 is provided, containing a rotatable perforated drum 215 where the laundry 220 to be washed can be loaded. The tub 210 and the drum 215 both have preferably a substantially cylindrical shape. A hollow space 225 is defined between the tub 210 and the drum 215. The housing 205 is provided with a loading/unloading door 230 which allows access to the washing tub 210 and the drum 215. The tub 210 is preferably suspended in a floating manner inside the housing 205, advantageously by means of a number of coil springs and shock-absorbers that are not illustrated in the enclosed Figures. The tub 210 is preferably connected to the housing 205 by means of an elastic bellows 235, or gasket.

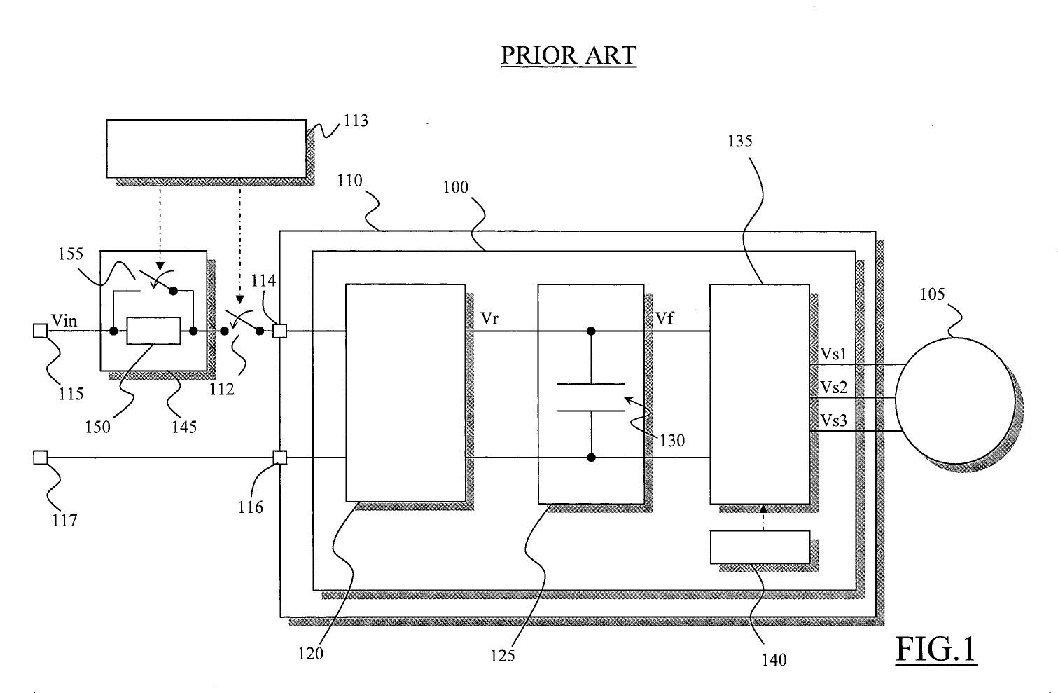

The drum 215 is advantageously rotated by an electric motor, such as the motor 105 of FIG. 1, which preferably transmits the rotating motion to the shaft 245 of the drum 215, advantageously by means of a belt/pulley system 250. In a different embodiment of the invention, not illustrated, the motor 105 can be directly associated with the shaft 245 of the drum 215. The motor 105 is supplied with a set of AC supply voltages Vs1, Vs2, Vs3 generated by an inverter supply block comprising an inverter, such as the inverter supply block 100 of FIG. 1. As described above, the inverter supply block 100 is mounted on a PCB 110 located within the housing 205, for example close to the motor 105 itself.

A water inlet circuit 255 is arranged preferably in the upper part of the washing machine 200 and is suited to supply an operative fluid including water and washing/rinsing products (i.e., detergent, softener, etc.) into the tub 210. The water inlet circuit 255 preferably comprises a removable drawer 260 provided with various compartments suited to be filled with washing and/or rinsing products. The water inlet circuit of a washing machine is well known in the art, and therefore will not be described in detail. In the embodiment herein described, the water is advantageously supplied into the tub 210 by making it flow through the drawer 260.

The washing machine 200 further comprises a water outlet circuit 265. The water outlet circuit 265 advantageously comprises a drain pump 270, a first pipe 275 connecting the tub 210 to the drain pump 270 and an outlet pipe 278 ending outside the housing 205. The water outlet circuit 265 is suited to drain the operative fluid from the tub 210 to the outside. Preferably the water outlet circuit 265 comprises a filtering device, not illustrated, connected upstream the drain pump 270 for protecting the latter from foreign bodies coming from the laundry.

Advantageously, the washing machine 200 comprises a heater circuit or apparatus 280 (hereinafter, simply referred to as heater apparatus) for heating up the operative fluid (e.g., free water and/or water mixed with washing and/or rinsing products) inside the tub 210. Preferably, the heater apparatus 280 is located within a sump provided at the bottom of the tub 210 and fluidly connected to the water outlet circuit 265. In the embodiment considered, the heater apparatus 280 comprises one or more insulated electric resistance heaters (not shown in FIG. 2) configured to be selectively activated by closing proper switches when the washing program carried out by the washing machine 200 requires to heat up the operative fluid inside the tub 210.

In the embodiment illustrated in the enclosed figures the laundry machine is a washing machine, and therefore the electrical heater apparatus 280 may be arranged for heating up free water and/or water mixed with washing and/or rinsing products, so as to wash the laundry with an operative fluid having a set temperature; also in case of a washing/drying machine the electrical heater apparatus 280 may be arranged for heating up free water and/or water mixed with washing and/or rinsing products.

However in a different embodiment, in which the laundry machine is a tumble dryer, but also in the case of a washing/drying machine, the electrical heater apparatus 280 may be arranged for heating up (or drying) the air before introducing it in the drum, so as to dry the laundry contained therein.

The washing machine 200 comprises a control unit, such as the control unit 113 illustrated in FIG. 1. The control unit 113 is connected to the various parts of the laundry washing machine 200 in order to ensure its operations. The control unit 113 is preferably, but not necessarily, connected to the water inlet circuit 255, the water outlet circuit 265, the heater apparatus 280, the electric motor 105 and the inverter supply block 100.

According to an embodiment of the present invention, the inrush current of the inverter supply block 100 during the bulk capacitor charging phase is limited by forcing the inrush current to flow through the resistance heaters of the heater apparatus 280. Since the washing machine 200 (or, more generally, the laundry machine) is already provided with such resistive elements, the solution according to an embodiment of the present invention allows avoiding the installation of a dedicated limiter circuit including a NTC thermistor, such as the limiter circuit 145 of FIG. 1.

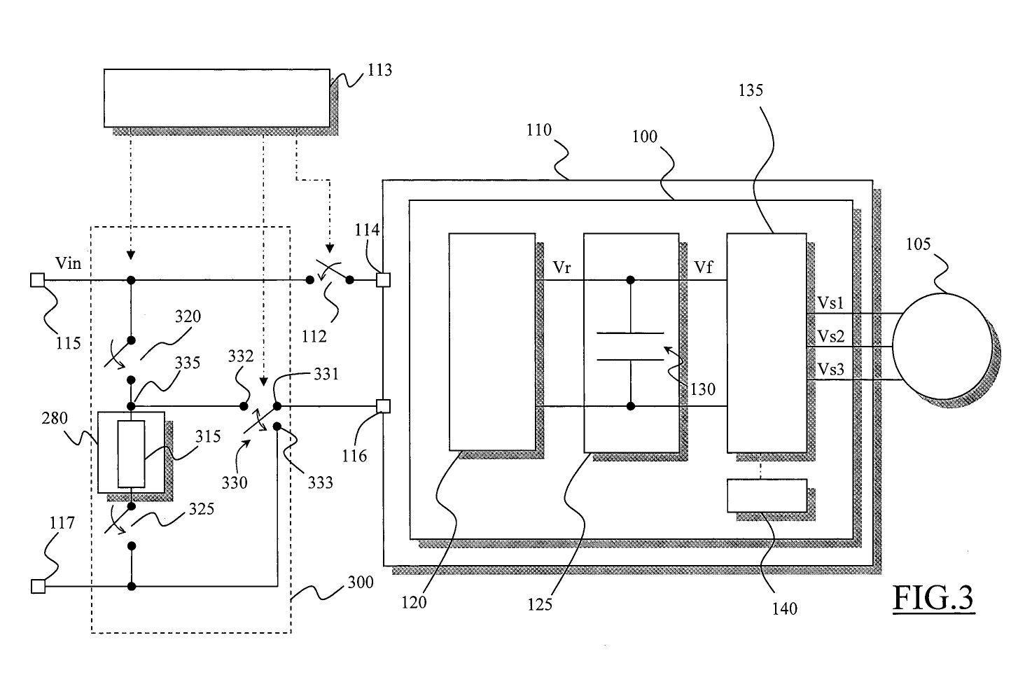

FIG. 3 schematically illustrates in terms of functional elements a limiter circuit 300 for limiting the inrush current of the inverter supply block 100 during the bulk capacitor charging phase according to an embodiment of the present invention. Clearly the following description can be applied both if the heater apparatus 280 is comprised in a washing machine or in a washing/drying machine and is arranged for heating the water or water mixed with washing/rinsing products, and also if the heater apparatus 280 is comprised in a tumble dryer or in a washing/drying machine and is arranged for heating the drying air.

The elements corresponding to those already shown in FIGS. 1 and 2 are denoted with the same references, and their explanation is omitted for the sake of brevity.

The heater apparatus 280 is schematized in figure with an electric resistance heater 315 with a first terminal coupled to the line terminal 115 through a switch 320 and a second terminal coupled to the neutral terminal 117 through a switch 325. Both the switches 320 and 325 are controlled by a logic circuit, such as the control unit 113 of the washing machine. In a further embodiment, not illustrated, the switches 320 and 325 may be comprised in the heater apparatus 280. When the heater apparatus 280 is activated, for example, in the case of a washing machine, for heating up the operative fluid included in the water tub 210 (see FIG. 2), both the switch 320 and 325 are closed, so that current flows through the electric resistance heater 315 from the line terminal 115 to the neutral terminal 117. Similar considerations apply if the heater apparatus 280 is structured in a different way, e.g., with a plurality of electric resistance heaters connected in parallel between the line terminal 305 and the neutral terminal 310 and individually activable for example through corresponding switches.

According to an embodiment of the present invention, the limiter circuit 300 for limiting the inrush current of the inverter supply block 100 during the bulk capacitor charging phase comprises the electric resistance heater 315 and the switches 320, 325, as well as a two-way switch 330 having an input terminal 331 coupled to the second terminal 116 of the inverter supply block 100, a first output terminal 332 coupled to the first terminal of the electric resistance heater 315 (circuit node 335), and a second output terminal 333 coupled to the neutral terminal 117. The two-way switch 330 is controlled, for example by the control unit 113 of the washing machine, in such a way that the input terminal 331 is selectively connectable either to the first output terminal 332 or to the second output terminal 333 thereof.

According to an embodiment of the present invention, the limiter circuit 300 allows to charge the (initially discharged) bulk capacitor 130 of the filter circuit 125 with a reduced inrush current in the following way.

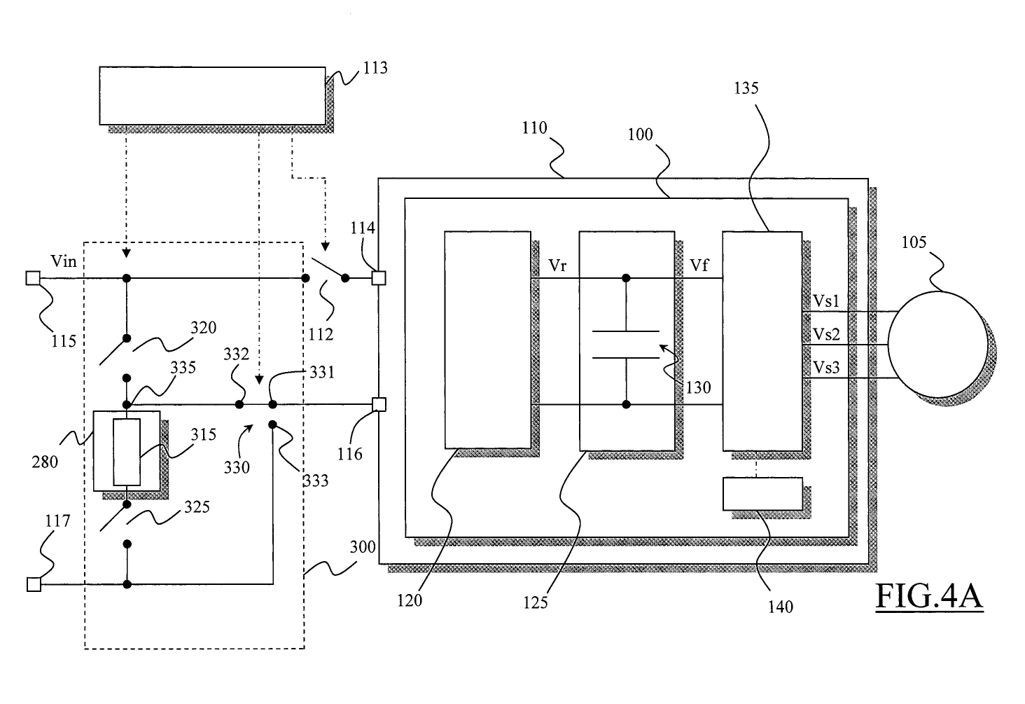

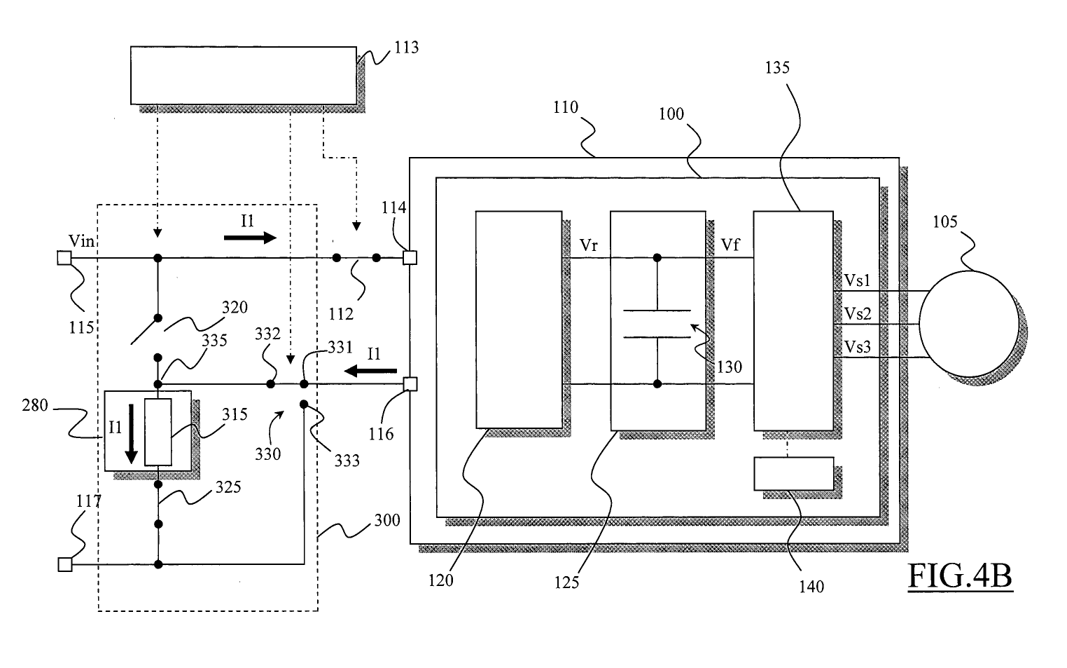

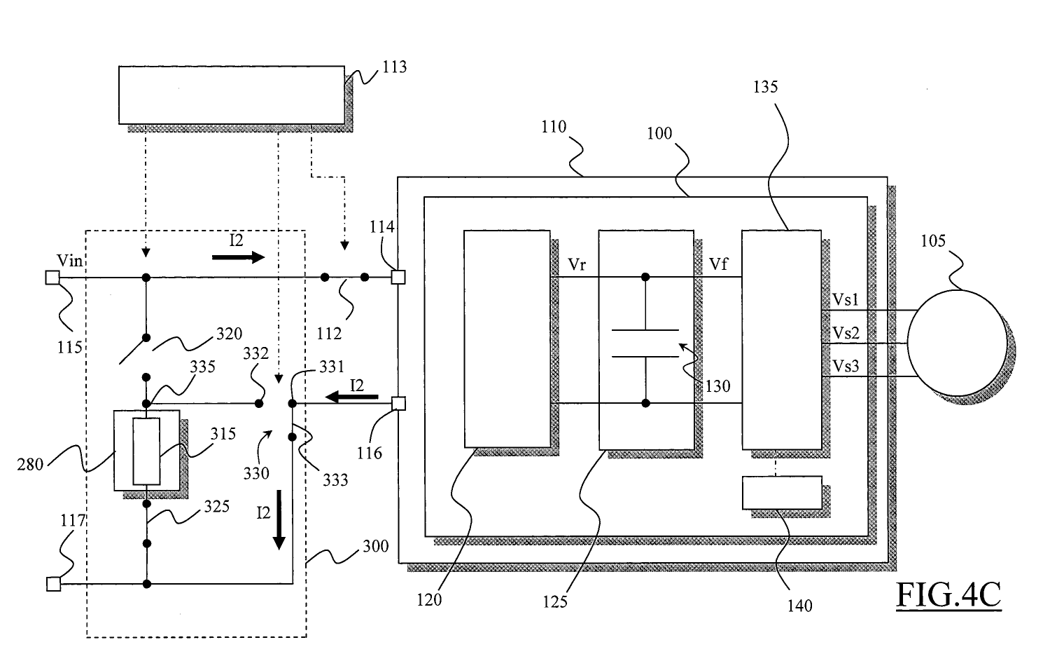

Prior to close the switch 112, and therefore prior to the activation of the inverter supply block 100, the two-way switch 330 has the input terminal 331 that is connected to the first output terminal 332, so that the second terminal 116 of the inverter supply block 100 is coupled to the circuit node 335; moreover, the switches 320 and 325 are open. In this situation, illustrated in FIG. 4A, no current is drawn by the inverter supply block 100.

As soon as the switch 112 is closed for activating the inverter supply block 100 to the purpose of supplying the motor 105 of the washing machine 200, the switch 325 is closed. In this way, as illustrated in FIG. 4B, the inverter supply block 100 draws from the mains a current I1. The current I1 is sourced by the line terminal 115, and enters the inverter supply block 100 via its first terminal 114 passing through the switch 112. The same current I1 is provided back to neutral terminal 117 via the second terminal 116 of the inverter supply block 100 passing through the two-way switch 330, the electric resistance heater 315, and the switch 325, respectively. Therefore, (a fraction of) the current I1 starts to charge the bulk capacitor 130. Thanks to the presence of the electric resistance heater 315, the current I1 drawn by the inverter supply block 100, i.e., its inrush current, results to be limited to a sufficiently low value such to avoid (or at least reduce) the damage of the components of the inverter supply block 100 and/or the blowing of fuses.

With the passing of time, the bulk capacitor 130 becomes sufficiently charged, and the maximum value of the current I1 drops.

After an amount of time that depends on the capacity of the bulk capacitor 130 as well as on the resistance of the electric resistance heater 315 and of the switches 112, 330, 325, the control unit 113 drives the two-way switch 330 in such a way that the input terminal 331 is connected to the second output terminal 333, so that the second terminal 116 of the inverter supply block 100 results to be coupled to the neutral terminal 117. The current drawn by the inverter supply block 100—illustrated in FIG. 4C with the reference I2—is still sourced by the line terminal 115, and enters the inverter supply block 100 via its first terminal 114 passing through the switch 112. The same current I2 is provided back to neutral terminal 117 via the second terminal 116 of the inverter supply block 100 passing through the two-way switch 330, in this case bypassing the electric resistance heater 315. Thanks to this arrangement, once the bulk capacitor 130 is sufficiently charged, the voltage drop previously introduced by the electric resistance heater 315 (see FIG. 4B) is removed, so that the inverter supply block 100 is fed with the (substantially) full input voltage Vin provided by the mains, and not only with a portion thereof.

Compared to the known solutions, the limiter circuit 300 according to the present invention does not provide for a dedicated NTC thermistor, since it exploits an already present resistive element (included in the resistance heater). Therefore, the solution according to the present invention is more efficient in terms of cost and space occupation.

Although in the present description reference has been explicitly made to an inverter supply block for a motor of a washing machine, the concepts of the present invention may be extended to a supply block adapted to drive as well other electrical devices included in a washing machine, such as for example compressors, pumps and/or fans.

In a further embodiment, not illustrated, a single limiter circuit analogous to the one described above may be applied to limit the charging current (inrush current) of two or more different inverter supply blocks provided in a laundry machine, for example an inverter supply block of the motor for rotating the drum and an inverter supply block of the motor of a draining pump; in this embodiment the single limiter circuit is connected to the input ports of different inverter supply blocks, in such a way that the input ports of such different inverter supply blocks are connected, in parallel one another, to the single limiter circuit.

Clearly if a laundry machine is provided with more than one electrical heater apparatus, as for example in the case of a washing/drying machine, and with more than one inverter supply block for electrically supplying more than one electrical devices (e.g. the motor for rotating the drum and a draining pump or a fan), there is the possibility to use each electrical heater apparatus in a different limiter circuit, analogous to the one described above, in order to limit the charging current of one or more of the inverter supply blocks provided in the laundry machine.

1. A laundry machine adapted to process laundry by means of an operative fluid, comprising:
a drum for housing the laundry;
an electrical heater apparatus configured to heat up the operative fluid;
at least one electrical device;
an inverter supply block for electrically supplying the at least one electrical device, the inverter supply block comprising a bulk capacitor, and
a limiter circuit configured to temporarily limit a charging current drawn by the inverter supply block during a bulk capacitor charging phase,
wherein the limiter circuit is configured to selectively force the passage of the charging current through the electrical heater apparatus.

2. The laundry machine of claim 1, wherein the electrical heater apparatus comprises at least one electric resistance heater, the limiter circuit being configured to selectively force the passage of the charging current through the at least one electric resistance heater during the bulk capacitor charging phase.

3. The laundry machine of claim 2, wherein the limiter circuit further comprises a first switch switchable between:
a first configuration, wherein the inverter supply block is coupled to an AC power supply for receiving the charging current through the at least one electric resistance heater, and
a second configuration, wherein the inverter supply block is coupled to the AC power supply for receiving the charging current bypassing the electric resistance heater.

4. The laundry machine of claim 3, wherein:
the AC power supply comprises a first supply terminal and a second supply terminal, the electrical heater apparatus being coupled between the first supply terminal and the second supply terminal, and
the inverter supply block includes a first input terminal selectively connectible to the first supply terminal through a further switch and a second input terminal selectively connectible to the second supply terminal or to the electrical heater apparatus through the first switch.

5. The laundry machine of claim 4, wherein the inverter supply block comprises:
a rectifier circuit adapted to convert a sinusoidal input voltage provided by the AC power supply into a unipolar rectified voltage;
a filter circuit adapted to generate a filtered voltage from the rectified voltage, the filter circuit including the bulk capacitor, and
an inverter circuit adapted to generate supply voltages for the at least one electrical device from the filtered voltage.

6. The laundry machine of claim 1, wherein the laundry machine is a selected one among:
a washing machine;
dryer machine, and
a washing/drying machine.

7. The laundry machine of claim 1, wherein said electrical device comprises at least one among:
an electric motor,
a compressor,
a pump, and
a fan.

8. A method for operating a laundry machine adapted to process laundry by means of an operative fluid, the laundry machine comprising:
a drum for housing the laundry;
an electrical heater apparatus configured to heat up the operative fluid;
at least one electrical device;
an inverter supply block for electrically supplying the at least one electrical device, the inverter supply block comprising a bulk capacitor, the method comprising:
temporarily limiting a charging current drawn by the inverter supply block during a bulk capacitor charging phase, said temporarily limiting a charging current comprising selectively forcing the passage of the charging current through the electrical heater apparatus.

9. The method of claim 8, wherein said selectively forcing the passage of the charging current through the electrical heater apparatus comprises selectively forcing the passage of the charging current through at least one electric resistance heater during the bulk capacitor charging phase.

10. The method of claim 9, further including:
coupling the inverter supply block to an AC power supply through the at least one electric resistance heater during the bulk capacitor charging phase, and
coupling the inverter supply block to the AC power supply bypassing the electric resistance heater after the bulk capacitor charging phase.
